(19) United States
(12) Patent Application Publication
(10) Pub. No.: US 2014/0201293 A1
(43) Pub. Date: Jul. 17, 2014

(54) CHOOSING A SERVICE TO PROVIDE A MESSAGE

(71) Applicant: TALK.TO FZC, Ras Al Khaimah (AE)

(72) Inventor: Bhavin Turakhia, Mumbai (IN)

(73) Assignee: Talk.to FZC, Ras Al Khaimah (AE)

(21) Appl. No.: 13/858,798

(22) Filed: Apr. 8, 2013

(30) Foreign Application Priority Data
Jan. 14, 2013 (IN) 111/MUM/2013

(51) Int. Cl. H04L 12/58

(52) U.S. Cl. CPC H04L 51/04
USPC 709/206

(57) ABSTRACT

A machine may be configured to receive a message within an inbound request from an application. The inbound request may ask that the message be provided to a device of a recipient that is identified by a device identifier of the device, and the inbound request may specify a time by which the message is to be provided. The machine may make a request to a first communication service that the first communication service provide the message to the device by the time specified. The machine may determine that the first communication service acknowledged this request but failed to receive a confirmation that references this request. Based on this determination, the machine may choose a second communication service to provide the message and make a request to the second communication service that the second communication service provide the message from the application to the device.

### PRIORITY APPLICATION(S)

This application claims the benefit of priority under 35 U.S.C. §119(a)-(d) to Indian Application No. 111/MUM/2013, filed Jan. 14, 2013, entitled “Choosing a Service to Provide a Message,” which is incorporated herein by reference in its entirety.

### TECHNICAL FIELD

The subject matter disclosed herein generally relates to the processing of data. Specifically, the present disclosure addresses systems and methods to facilitate choosing a service to provide a message.

### BACKGROUND

A device (e.g., as an example of a machine) may be configured to use one or more services that provide communication functionality (e.g., communication services). For example, a device may be connected to a network (e.g., a wired network, a wireless network, or both), and the device may be configured (e.g., by software, hardware, or both) to communicate (e.g., send, receive, or both) messages via the network according to one or more communications protocols supported by one or more services (e.g., communication services). Examples of such services include telephony services (e.g., analog or digital voice telephony services, including Voice over IP (VoIP) services), instant messaging (IM) services (e.g., text-based chat services, including Internet chat services), text messaging services (e.g., short message services (SMS)), video conference services (e.g., analog or digital video phone services, including webcam-based services supporting video, audio, or both), and any suitable combination thereof.

### BRIEF DESCRIPTION OF THE DRAWINGS

Some embodiments are illustrated by way of example and not limitation in the figures of the accompanying drawings.

FIGS. 1 and 2 are network diagrams illustrating a network environment suitable for choosing a service to provide a message, according to some example embodiments.

FIG. 3 is a block diagram illustrating components of a server machine suitable for choosing the service to provide the message, according to some example embodiments.

FIG. 4 is a data structure diagram illustrating a request to provide the message, according to some example embodiments.

FIG. 5 is a flowchart illustrating data flows within the network environment, according to some example embodiments.

FIGS. 6 and 7 are flowcharts illustrating operations of the server machine in performing a method of choosing the service to provide the message, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to choosing a service to provide a message. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine may be configured (e.g., by software modules) to function as a server machine (e.g., an application programming interface (API) server machine) that may be used by external applications (e.g., executing on a third-party application server) to choose a communication service for providing a message to a device that corresponds to a recipient of the message. The machine may receive a message within an inbound request from an application. The inbound request may constitute all or part of a request that the message be provided to the device of the recipient. The recipient may be identified by a device identifier (e.g., phone number, network address, or hardware identifier) of the device. Moreover, the inbound request may specify a time by which the message is to be provided to the device. For example, the inbound request may specify a delivery time by which the message is to be delivered to the device, a read time by which the message is to be presented (e.g., displayed) to the recipient (e.g., as indicated by a detection of an input from the recipient while the message is being presented), or both.

The machine may make a first request to a first communication service (e.g., an IM service) among multiple available communication services. The first request may ask that the first communication service provide the message to the device by the time specified in the inbound request. Provision of the message to the device may be based on the device identifier (e.g., phone number) of the device.

The machine may determine that the first communication service acknowledged the first request but failed to receive a confirmation that references the first request, the message, or both. In some example embodiments, the machine may determine that the first communication service failed to provide such a confirmation to the machine. Such a confirmation may be or include a “delivery confirmation” that the device received a message by a delivery time specified in the inbound request, a “read confirmation” that the recipient read the message by a read time specified in the inbound request, or both.

Based on this determination, the machine may choose a second communication service (e.g., an SMS service or another IM service) among the multiple available communication services. Accordingly, the machine may make a second request to the second communication service. The second request may ask that the second communication service provide the message to the device (e.g., based on the device identifier of the device). In some example embodiments, the message is a “rich” message (e.g., containing formatted text, audio, an image, video, or any suitable combination thereof), and the machine may convert the message to plain text from provision via the second communication service. In such example embodiments, the plain text message may be provided with a locator (e.g., uniform resource locator (URL)) by which the original rich message may be accessed.

In various example embodiments, the multiple available communication services are ranked (e.g., sorted within a list stored by the machine). The communication services may be ranked by cost to provide the message to the device. For example, the first communication service may be an IM service that is managed by a social networking service (e.g., Facebook®, Twitter®, or LinkedIn), while the second communication service may be an SMS service that is managed by a mobile telephony service (e.g., AT&T® or Verizon®). The first communication service may be ranked higher than the second communication service (e.g., within a list that is sorted by increasing cost per message), and the machine may make the first request to the first communication service based on its higher rank (e.g., lower cost per message). As described above, where the first communication service is determined (e.g., by the machine) to have acknowledged the first request but not received a confirmation (e.g., that references the first request, the message, or both), the machine may choose the second communication service that is a lower ranked (e.g., higher cost per message) alternative for providing the message to the device. According to some example embodiments, the ranking of the first and second communication services may be based on quality of service in delivering one or more messages to the recipient or to a device thereof (e.g., a score indicative of reliability or error rate, a score indicative of delivery speed, or any suitable combination thereof, such as a probability that a message will be successfully delivered within 10 minutes).

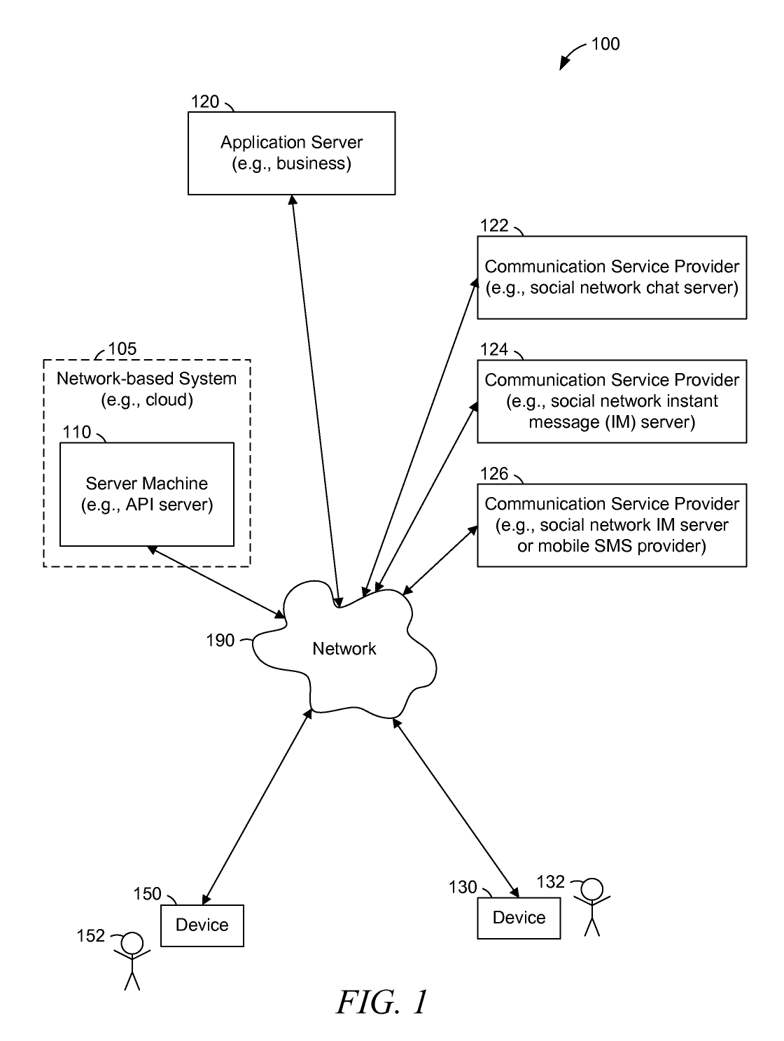

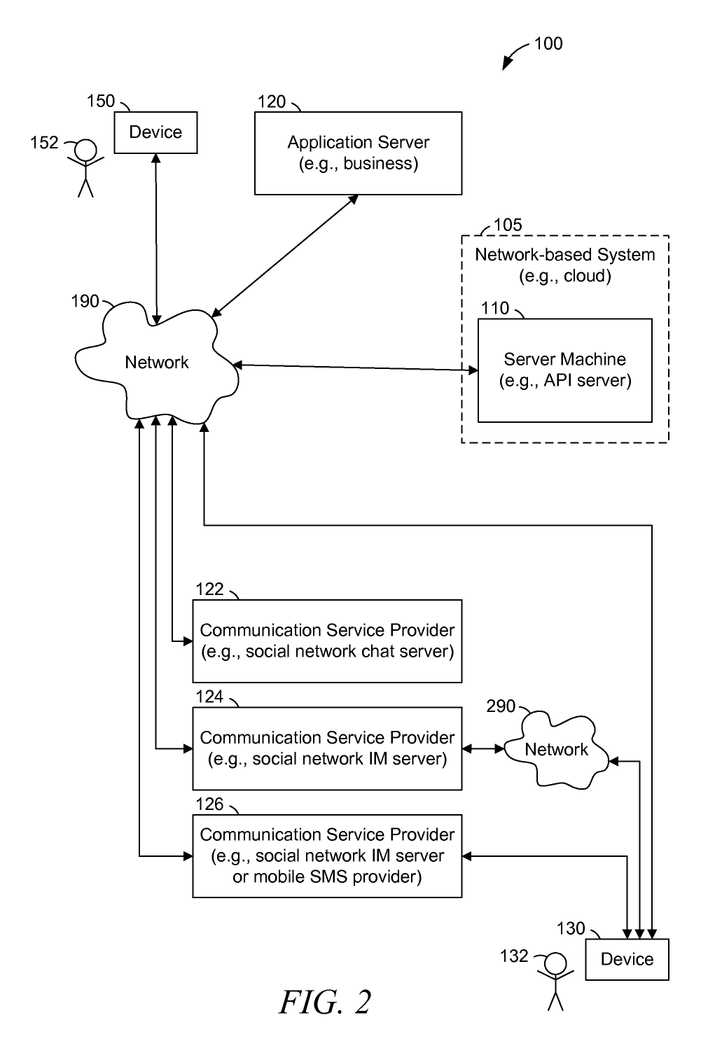

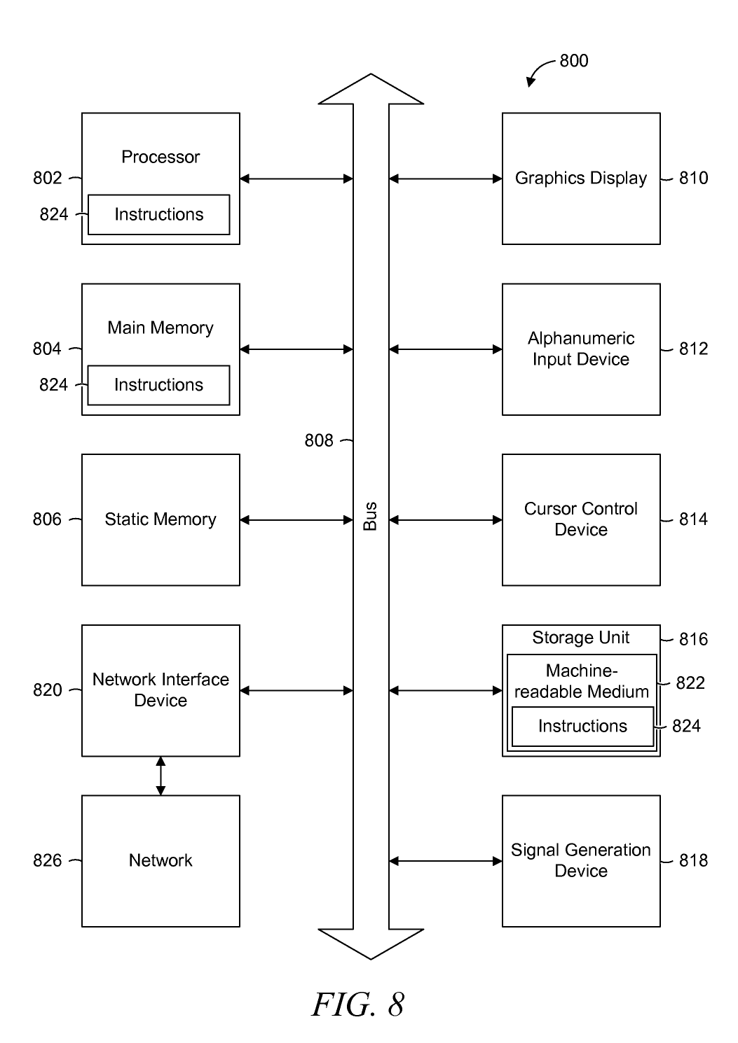

FIGS. 1 and 2 are network diagrams illustrating a network environment 100 suitable for choosing a communication service, as an example of a service, to provide a message (e.g., received from an application), according to some example embodiments. The network environment 100 includes a server machine 110, an application server 120, communication service providers 122, 124, and 126, and devices 130 and 150, all communicatively coupled to each other via a network 190. The server machine 110, the application server 120, the communication service providers 122, 124, and 126, and the devices 130 and 150 may each be implemented in a computer system, in whole or in part, as described below with respect to FIG. 8.

The server machine 110 may be configured as an API server, and the server machine 110 may form all or part of a network-based system 105. The network-based system 105 may be configured to provide one or more services (e.g., accessible via an API) that are usable to provide a message to a device (e.g., device 130) via one or more of the communication service providers 122, 124, and 126.

The application server 120 may correspond to a business (e.g., a bank or merchant), and the application server 120 may execute one or more applications that are configured to communicate a message to a device (e.g., device 130) of a recipient for the message. In some situations, the message may be requested to be provided by a particular time (e.g., an urgent message, real-time message, or a message with a topic for which the recipient has set a preference for prompt delivery). Accordingly, an application executing on the application server 120 may request (e.g., via one or more API calls) that the server machine 110 provide a message to a device by the time specified in a request (e.g., an API call). In some example embodiments, the device 150 may be configured as described herein with respect to the application server 120 and execute one or more applications configured to communicate a message to a device (e.g., device 130).

The communication service provider 122 may form all or part of a network-based system that provides a communication service (e.g., an IM service, a text messaging service, a telephony service, or a videoconference service). Similarly, the communication service provider 124 may form all or part of another network-based system that provides another communication service. Likewise, the communication service provider 126 may form all or part of the further network-based system that provides a further communication service. Herein, the communication service provider 124 may be referred to as a “first communication service provider” that provides a “first communication service;” the communication service provider 126 may be referred to as a “second communication service provider” that provides a “second communication service;” and the communication service provider 122 may be referred to as a “third communication service provider” that provides a “third communication service.”

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

As shown in FIG. 2, the application server 120, the device 150, or both, may each execute an application configured to communicate a message to the user 132 via the device 130. The user 132 may be considered as the recipient of the message. Such an application may send a request (e.g., an “inbound request,” from the perspective of the server machine 110) to the server machine 110. The request may seek provision of the message to the device 130 by a time specified in the request, and the request may identify the user 132 (e.g., as the recipient of the message) by a device identifier (e.g., phone number) of the device 130.

As shown in FIG. 2, multiple communication service providers 122, 124, and 126 (e.g., with their respective communication services) are available for selection to provide the message to the device 130. The communication service providers 122, 124, and 126 may constitute a plurality of communication service providers that provide a plurality of communication services.

A communication service provider (e.g., communication service provider 122) is shown as being connected to the device 130 by the network 190, which illustrates that one or more communication service providers may able to provide the message to the device 130 via the network 190 (e.g., a public network, such as the Internet). A communication service provider (e.g., communication service provider 124) is shown as being connected to the device 130 by a separate network 290 (e.g., a private network, such as a cellular network), which illustrates that one or more communication service providers may provide the message to the device via the separate network 290. A communication service provider (e.g., communication service provider 126) is shown as being connected (e.g., directly or indirectly) to the device 130, which illustrates that one or more communication service providers may provide the message to the device 130 via a connection to the device 130.

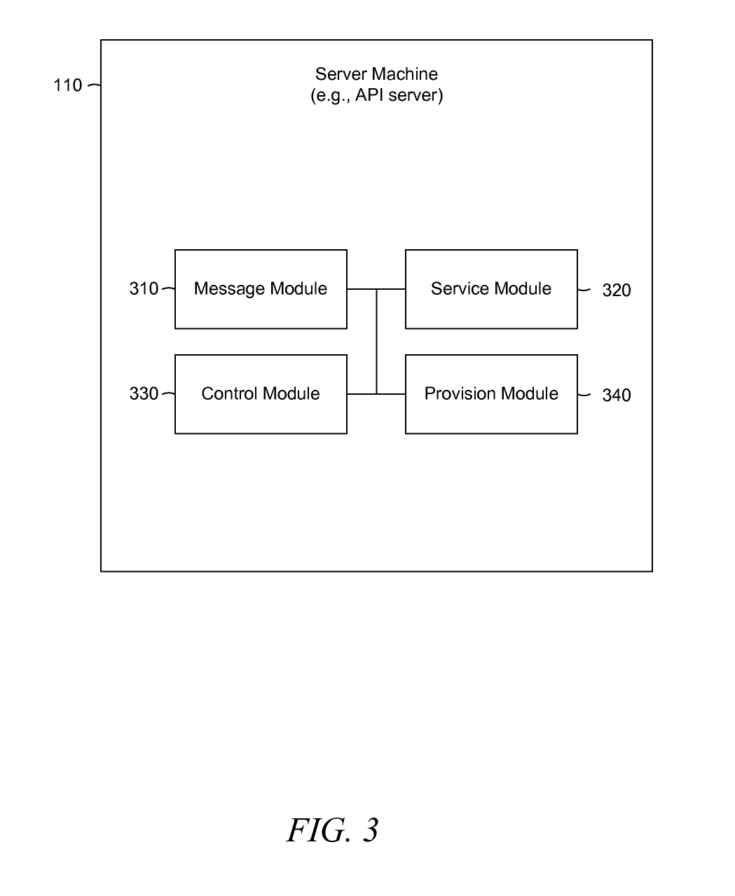

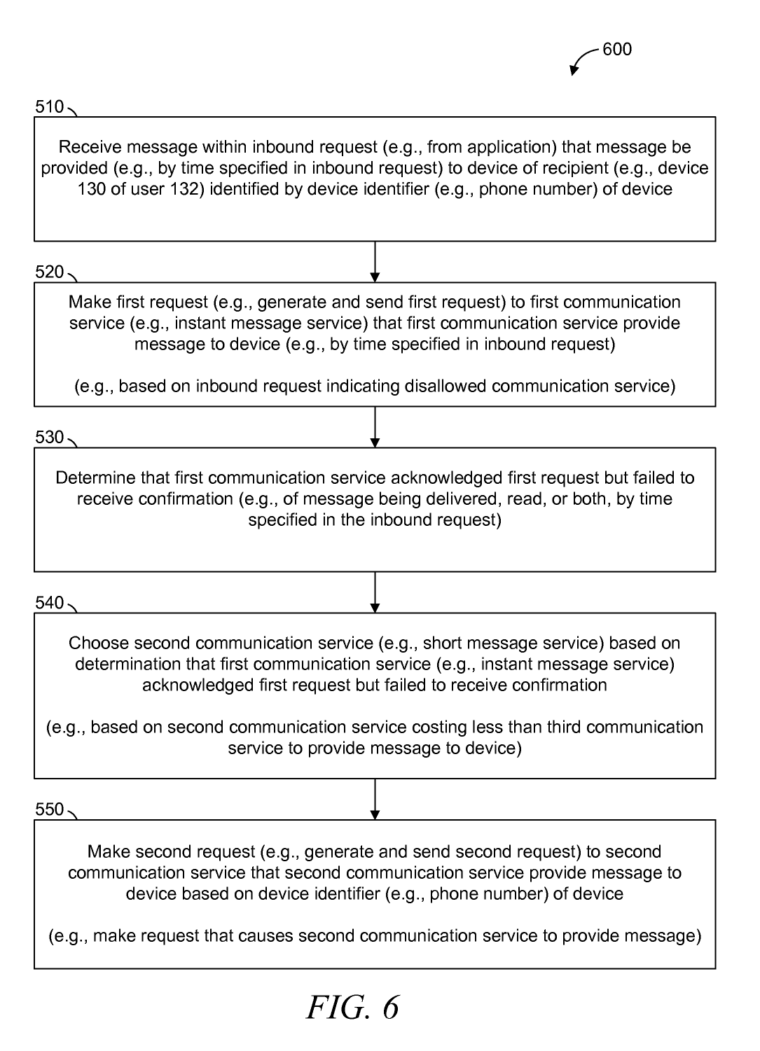

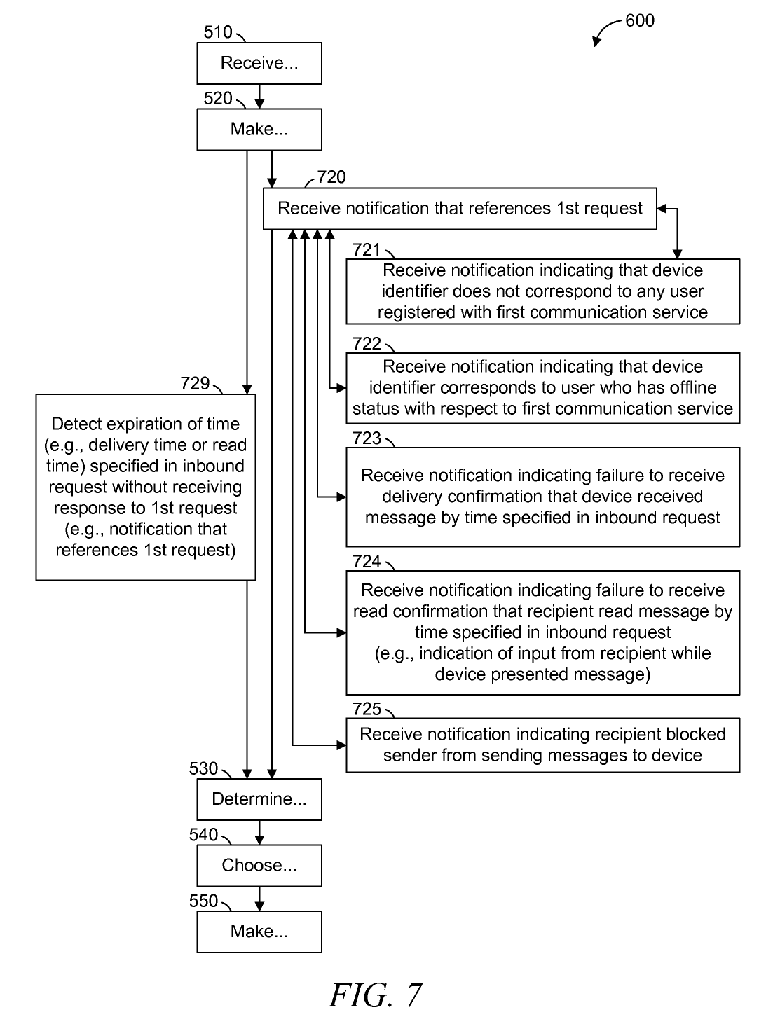

FIG. 3 is a block diagram illustrating components of the server machine 110, according to some example embodiments. The server machine 110 is shown as including a message module 310, a service module 320, a control module 330, and a provision module 340, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. Functions of the modules within the server machine 110 are described below with respect to FIG. 6-7.

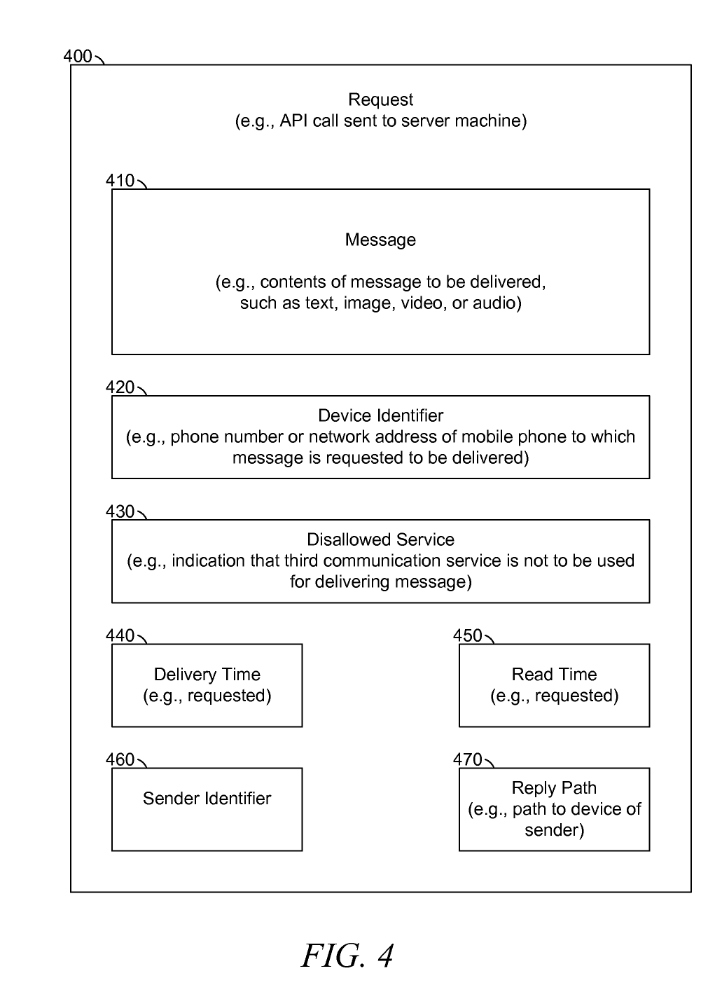

FIG. 4 is a data structure diagram illustrating a request 400 to provide a message 410, according to some example embodiments. The request 400 may form all or part of an API call sent from an application (e.g., executing on the application server 120) to the server machine 110 (e.g., to the message module 310). From the standpoint of the server machine 110, the message 410 may be an inbound request that is received from such an application. The inbound request may ask that the message 410, which is shown as being included in the request 400, be provided to the device 130.

As shown in FIG. 4, the request 400 includes the message 410. The message 410 may be or include informational content (e.g., a message payload) to be delivered. For example, the message 410 may be or include text data (e.g., alphanumeric characters), image data (e.g., a picture, such as a photograph), video data (e.g., a movie or video file, or portion thereof), audio data (e.g., an audio or sound file, or portion thereof), or any suitable combination thereof.

The request 400 is also shown as including a device identifier 420 that identifies the device 130, the user 132, or both. For example, the device identifier 420 may be a phone number of the device 130 (e.g., where the device 130 is a mobile phone or smart phone). As another example, the device identifier 420 may be or include a network address (e.g., assigned by the network 190), a hardware identifier (e.g., a serial number or globally unique identifier set by a manufacturer of the device 130), or any suitable combination thereof.

The request 400 is further shown as including an indicator 430 of a disallowed service. The indicator 430 may indicate that a communication service (e.g., provided by the communication service provider 122) is disallowed (e.g., not to be used or attempted) for providing the message 410. According to various example embodiments, inclusion of the indicator 430 within the request 400 indicates that the communication service provider 122 (e.g., including one or more applications executing thereon), its corresponding communication service, or both, are disallowed for providing (e.g., delivering or conveying) the message 410.

The request 400 may include a delivery time 440 (e.g., a requested delivery time). For example, the delivery time 440 may specify (e.g., within the request 400) a time by which the message 410 is to be provided to the device 130.

The request 400 may include a read time 450 (e.g., a requested read time), for example, the read time 450 may specify (e.g., within the request 400) a time by which an indication that the device 130 detected an input from the user 132 (e.g., as the recipient of the message 410) while the message was being presented to the user 132 by the device 130.

According to some example embodiments, the request 400 includes a sender identifier 460. The sender identifier 460 may indicate (e.g., specify, define, or identify) a source (e.g., sender or transmitter) that generated the message 410, initiated the message 410, authorized the message 410, or any suitable combination thereof. For example, the sender identifier 460 may identify the application server 120, its corresponding business, or both. As another example, the sender identifier 460 may identify the user 152, its corresponding device 150, or both. As a further example, the sender identifier 460 may be a name of an application (e.g., executing on the application server 120) and may identify that application as the source of the message 410.

According to certain example embodiments, the request 400 includes a reply path 470. The reply path 470 indicates a network path (e.g., a sequence of one or more network servers) by which a reply to the message 410 may be sent to the source of the message.

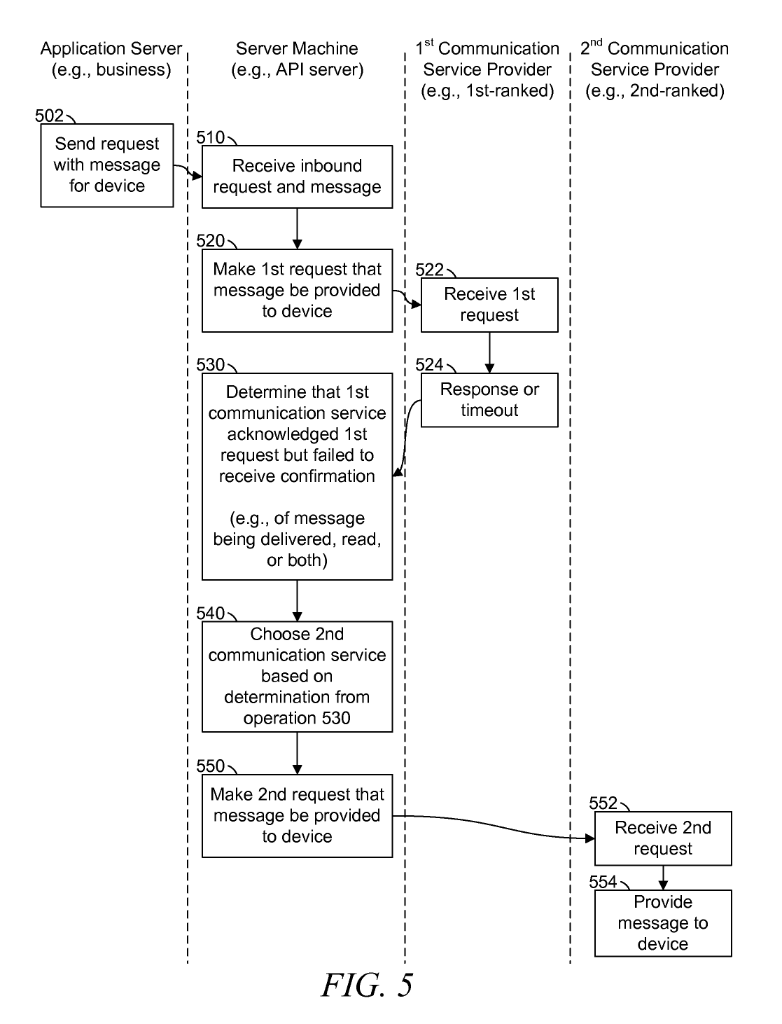

FIG. 5 is a flowchart illustrating data flows within the network environment 100, according to some example embodiments. In operation 502, the application server 120 (e.g., as configured by an application executing thereon) sends the request 400 to the server machine 110. That is, an application executed by the application server 120 may send a request 400 to the server machine 110. In some example embodiments, the device 150 is configured to perform the sending of the request 400 to the server machine 110. As noted above, the request 400 includes the message 410, which is requested to be provided to the device 130.

In operation 510, the server machine 110 receives the request 400 and its included message 410. In other words, the server machine 110 receives the message 410 within the request 400. As noted above, the request 400 may be an inbound request that the message 410 be provided by a time specified in the request 400 (e.g., delivery time 440, read time 450, or both).

In operation 520, the server machine 110 makes a first request to the communication service provider 124 (e.g., a first communication service provider, a first-ranked communication service provider, a higher-ranked communication service provider, a lower-cost communication service provider, or any suitable combination thereof). This first request may ask that the message 410 be provided to the device 130 via the communication service (e.g., IM service) that is offered, managed, or supported by the communication service provider 124. As noted above, the request may specify a time (e.g., delivery time 440, read time 450, or both) by which the message 410 is requested to be provided to the device 130.

In certain example embodiments, the first request, made in operation 520, specifies that the communication service provider 124, its corresponding communication service, or both, to provide the message 410 with an option that the recipient (e.g., user 132) may select. For example, such a selectable option may be a user-configurable preference or other parameter that fully or partially configures the communication service provided by the communication service provider 124 (e.g., provided to the user 132, the device 130, or both). As an example, the option may be an option to block the application server 120 (e.g., an application executing thereon), its corresponding business, or both, from sending future messages to the user 132, to the device 130, or both. As another example, the option may be an option to ignore (e.g., automatically dismiss or delete) future messages from the application server 120 (e.g., an application executing thereon), its corresponding business, or both. In some example embodiments, if more than a threshold number of users (e.g., recipients) block or ignore the application server 120 (e.g., an application executing thereon), its corresponding business, or both, then the server machine 110 may disallow further inbound requests therefrom. As a further example, the option may be an option to reply to the application server 120 (e.g., an application executing thereon), its corresponding business, or both. Such a reply may be initiated (e.g., composed, started, or sent) based on the reply path 470 within the request 400.

In some example embodiments, the request 400 includes the indicator 430 of the disallowed service (e.g., a communication service that is disallowed for providing the message 410). In such example embodiments, the disallowed communication service may constitute a further communication service that is provided by the communication service provider 122 (e.g., a third communication service provider, providing a third communication service), and operation 510 may be performed based on the request 400 including the indicator 430, which may indicate that the communication service provider 122 is disallowed for providing the message 410. In some situations, even if the communication service provider 122 is ranked higher (e.g., has a lower cost per message) than the communication service provider 124, the first request made in operation 520 may be made to the communication service provider 124, rather than the communication service 122, based on the indicator 430 being included in the request 400.

In some example embodiments, the server machine 110 ranks various communication services (e.g., as provided by communication service providers 124 and 126) by cost to provide the message 410 to the device 130 (e.g., cost per message). In some situations, the communication service provider 124, its corresponding communication service, or both, costs less to provide the message 410 than the communication service provider 126, its corresponding communication service, or both. Accordingly, the making of the first request in operation 520 may be based on the communication service provider 124, its corresponding communication service, or both, costing less than the communication service provider 126, its corresponding communication service, or both, to provide the message 410 to the device 130. In various example embodiments, communication services are ranked by other factors in addition to, or in lieu of, cost. Examples of such other factors include reliability (e.g., as measured by server uptime or number of undelivered messages per month), speed (e.g., as measured by time to acknowledge or confirm a request to provide a message), user preferences (e.g., as stored in a user profile), or any suitable combination thereof.

In operation 522, the communication service provider 124 receives the first request from the server machine 110. In operation 524, the communication service provider 124 either provides a response (e.g., a confirmation or a notification) or remains unresponsive to the server machine 110 beyond expiration of the time specified in the request 400 (e.g., timeout). Such a response may include acknowledgment of the first request, an acknowledgment that the message 410 was requested for provision to the device 130, a notification that indicates non-delivery of the message 410 (e.g., a failure of an attempt to deliver the message 410, or an expiration of a time period for making attempts to deliver the message 410), a notification that indicates an inability to fulfill the first request (e.g., due to a temporary service outage), or any suitable combination thereof.

In operation 530, the server machine 110 determines that the communication service provider 124, its corresponding communication service, or both, acknowledged the first request but failed to receive a confirmation that references the request 400, the message 410, or both. For example, such a confirmation may confirm that the message was delivered (e.g., received by the device 130) by the delivery time 440, that the message was read (e.g., as indicated by an input from the user 132 while the message was being presented to the user 132 by the device 130) by the read time 450, or both. In some example embodiments, the server machine 110 may determine that the communication service provider 124, its corresponding communication service, or both, failed to provide such a confirmation to the server machine 110.

According to some example embodiments, operations 520, 522, 524, and 530 may also be performed with one or more additional communication service providers (e.g., IM service providers), in a manner similar to that described above. Hence, the server machine 110 may make one or more further requests, similar to the request 400, to one or more additional communication service providers. Such further requests may be made based on rankings of the additional communication service providers (e.g., based on costs, reliability, speed, user preferences, or any suitable combination thereof). Hence, the making of the first request in operation 520 may be based on a determination that a further communication service provider, its corresponding communication service, or both, acknowledged but failed to fulfill such a further request.

In operation 540, the server machine 110 chooses (e.g., selects or identifies) the communication service provider 126 (e.g., a second communication service provider, a second-ranked communication service provider, a lower-ranked communication service provider, a higher-cost communication service provider, or any suitable combination thereof) for provision of the message 410 to the device 130. This choice may be based on the determination made in operation 530.

In certain example embodiments, the server machine 110 ranks various communication services (e.g., as provided by communication service providers 124 and 126) by cost to provide the message 410 to the device 130 (e.g., cost per message). In certain situations, the communication service provider 126, its corresponding communication service, or both, costs less to provide the message 410 than another communication service provider (e.g., a further communication service provider), its corresponding communication service, or both. Accordingly, the choosing of the communication service provider 126 in operation 540 may be based on the communication service provider 126, its corresponding communication service (e.g., an SMS service), or both, costing less than another communication service provider, its corresponding communication service (e.g., a more expensive SMS service), or both, to provide the message 410 to the device 130.

In operation 550, the server machine 110 makes a second request, and the second request may be made to the communication service provider 126 chosen in operation 540. This second request may ask that the message 410 be provided to the device 130 via the communication service (e.g., SMS service) that is offered, managed, or supported by the communication service provider 126. According to various example embodiments, the second request is configured to cause the communication service provider 126 to provide the message 410 to the device 130.

In some example embodiments, the sender identifier 460 within the request 400 is or includes a name of an application from which the request 400 is received. In such example embodiments, the second request made in operation 550 may cause the communication service provider 126, its corresponding communication service, or both, to provide the message 410 with the name of the application. For example, the name of the application may be indicated as a source (e.g., sender or transmitter) of the message 410.

In certain example embodiments, the second request, made in operation 550, causes the communication service provider 126, its corresponding communication service, or both, to provide the message 410 with an option that the recipient (e.g., user 132) may select. For example, such a selectable option may be a user-configurable preference or other parameter that fully or partially configures the communication service provided by the communication service provider 126 (e.g., provided to the user 132, the device 130, or both). As an example, the option may be an option to block the application server 120 (e.g., an application executing thereon), its corresponding business, or both, from sending future messages to the user 132, to the device 130, or both. As another example, the option may be an option to ignore (e.g., automatically dismiss or delete) future messages from the application server 120 (e.g., an application executing thereon), its corresponding business, or both. In some example embodiments, if more than a threshold number of users (e.g., recipients) block or ignore the application server 120 (e.g., an application executing thereon), its corresponding business, or both, then the server machine 110 may disallow further inbound requests therefrom. As a further example, the option may be an option to reply to the application server 120 (e.g., an application executing thereon), its corresponding business, or both. Such a reply may be initiated (e.g., composed, started, or sent) based on the reply path 470 within the request 400.

In operation 552, the communication service provider 126 receives the second request from the server machine 110. In operation 554, the communication service provider 126 provides the message 410 to the device 130 (e.g., via the network 190 or other communication path). Operation 554 may be caused by the second request (e.g., made by the server machine 110 in operation 550). The providing of the message 410 to the device 130 may be based on the device identifier 420 of the device 130.

FIGS. 6 and 7 are flowcharts illustrating operations of the server machine 110 in performing a method 600 of choosing a communication service to provide the message 410, according to some example embodiments. Operations in the method 600 may be performed by the server machine 110, using modules described above with respect to FIG. 3. As shown in FIG. 6, the method 600 may include operations 510, 520, 530, 540, and 550, each of which are described above with respect to FIG. 5. According to various example embodiments, operation 510 may be performed by the message module 310. Operation 520 may be performed by the service module 320. Operation 530 may be performed by the control module 330. Operation 540 may be performed by the service module 320, and operation 550 may be performed by the service module 320.

As shown in FIG. 7, some example embodiments of the method 600 include operation 720, which may be performed before operation 530. In alternative example embodiments, the method 600 includes operation 729, which may be performed before operation 530.

In operation 720, the service module 320 receives a notification (e.g., as a response to the first request, discussed above with respect to operation 520) that references the first request. The notification may be received from the communication service provider 124 to which the first request was made in operation 520. In example embodiments that include operation 720, operation 530 may be performed based on the notification received in operation 720.

Operation 721 may be performed as part (e.g., a precursor task, a subroutine, or a portion) of operation 720. In operation 721, the service module 320 receives the notification by receiving a notification that indicates that the device identifier 420 does not correspond to any user (e.g., message recipient) registered with the communication service provider 124, its corresponding communication service, or both. For example, the notification may be or include an error message that states the device identifier 420 (e.g., phone number) is not found within a database of registered users of the communication service provided by the communication service provider 124. In example embodiments that include operation 721, operation 530 may be performed based on the notification that indicates that the device identifier 420 fails to correspond to any registered user.

Operation 722 may be performed as part of operation 720. In operation 722, the service module 320 receives the notification by receiving a notification that indicates that the device identifier 420 of the device 130 corresponds to a user that is registered with the communication service provider 124, its corresponding communication service, or both, but that this user has an offline status. For example, the notification may indicate that the user which corresponds to the device identifier 425 is not logged into the communication service, has an inactive membership, has an unpaid membership, or any suitable combination thereof. In example embodiments that include operation 722, operation 530 may be performed based on the notification that indicates that the user is registered but has an offline status.

Operation 723 may be performed as part of operation 720. In operation 723, the service module 320 receives the notification by receiving a notification that indicates a failure (e.g., by the communication service provider 124, its corresponding communication service, or both) to receive a delivery confirmation that the device 130 received the message 410 by the time specified in the request 400 (e.g., delivery time 440). For example, the service module 320 may receive a notification (e.g., from the communication service provider 124) that indicates non-delivery of the message 410 (e.g., a failure of an attempt to deliver the message 410, or an expiration of a time period for making attempts to deliver the message 410). By receiving such a notification in operation 723, the service module 320 may fail to receive a delivery confirmation that the message was delivered (e.g., received by the device 130) by the delivery time 440. In example embodiments that include operation 723, operation 530 may be performed based on the notification that indicates the failure to receive the delivery confirmation.

Operation 724 may be performed as part of operation 720. In operation 724, the service module 320 receives the notification by receiving a notification that indicates a failure (e.g., by the communication service provider 124, its corresponding communication service, or both) to receive a read confirmation that the recipient (e.g., user 132) read the message by the time specified in the request 400 (e.g., read time 450). For example, the service module 320 may receive a notification (e.g., from the communication service provider 124) that indicates that the message 410 has not been read (e.g., as indicated by an input from the user 132 while the message was being presented to the user 132 by the device 130) by the read time 450. By receiving such a notification in operation 724, the service module 320 may fail to receive a read confirmation that the message was read (e.g., by the user 132) by the read time 450. In example embodiments that include operation 724, operation 530 may be performed based on the notification that indicates the failure to receive the read confirmation.

Operation 725 may be performed as part of operation 720. In operation 725, the service module 320 receives the notification by receiving a notification that indicates that the recipient (e.g., user 132) has blocked a sender (e.g., application server 120, its corresponding business, or both) of the message 410 from sending messages to the device 130 (e.g., via the communication service provider 124 or its corresponding communication service). For example, the service module 320 may receive a notification (e.g., from the communication service provider 124) that indicates that the device 130, the user 132, or both, correspond to a user preference that the communication service provider 124, its corresponding communication service, or both, disallow communications from the application server 120 (e.g., including any applications executing thereon), its corresponding business, or both. In example embodiments that include operation 725, operation 530 may be performed based on the notification that indicates that the sender is blocked from sending messages to the device 130 (e.g., via the communication service provider 124).

In operation 729, the service module 320 detects an expiration of a time specified in the request 400 (e.g., delivery time 440, read time 450, or both), without receiving a response (e.g., a confirmation or notification) that references the first request made in operation 520, the message 410, or both (e.g., without receiving a response to the first request). That is, the service module 320 may detect that the communication service provider 124 remains unresponsive to the server machine 110 beyond the expiration of the time specified in the request 400 (e.g., timeout). For example, the service module 320 may detect that the time specified in the request 400 has expired without receiving a notification (e.g., from the communication service provider 124, its corresponding communication service, or both) that any delivery confirmation or read confirmation was received by the communication service provider 124 or its corresponding communication service. In example embodiments that include operation 729, operation 530 may be performed based on the detected expiration of the time specified in the request 400.

According to various example embodiments, one or more of the methodologies described herein may facilitate selection of a service to provide a message. Moreover, one or more of the methodologies described herein may facilitate identification, selection, and usage of a lowest-cost communication service among multiple communication services that are currently (e.g., immediately) available to provide a message from an application to a device. Hence, one or more of the methodologies described herein may facilitate efficient and cost-effective automated routing of messages from applications to devices.

When these effects are considered in aggregate, one or more of the methodologies described herein may obviate a need for certain efforts or resources that otherwise would be involved in provision of messages to devices. Efforts expended by a user, administrator, or developer in making multiple attempts to find a service that is able to promptly (e.g., immediately) provide the message from an application to a device may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 8 is a block diagram illustrating components of a machine 800, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed, in whole or in part. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 (e.g., network 190) via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A method comprising:

receiving a message within an inbound request from an application that the message be provided by a time specified in the inbound request to a device of a recipient identified within the inbound request by a phone number of the device;
making a first request to an instant message service among a plurality of communication services that the instant message service provide the message to the device based on its phone number by the time specified in the inbound request;
determining that the instant message service acknowledged the first request but failed to receive a confirmation selected from a group consisting of: a delivery confirmation that the device received the message by the time specified in the inbound request, and a read confirmation that the recipient read the message by the time specified in the inbound request;
choosing a short message service among the plurality of communication services based on the determining that the instant message service acknowledged the first request but failed to receive the confirmation by the time specified in the inbound request received from the application, the choosing being performed by a processor of a machine; and
making a second request to the short message service that the short message service provide the message to the device, the second request causing the short message service to provide the message to the device based on its phone number.

2. The method of description 1, wherein:

the determining that the instant message service failed to receive the confirmation is based on expiration of the time specified in the inbound request without receiving a notification from the instant messaging service that the confirmation was received by the instant messaging service.

3. The method of description 1 further comprising:

receiving a notification that references the first request from the instant message service; and wherein
the determining that the instant message service failed to receive the confirmation is based on the notification received.

4. The method of description 3, wherein:

the notification indicates that the phone number of the device does not correspond to any user registered with the instant message service.

5. The method of description 3, wherein:

the notification indicates that the phone number of the device corresponds to a user registered with the instant message service but the user has an offline status with respect to the instant message service.

6. The method of any of descriptions 3-5, wherein:

the notification indicates a failure by the instant message service to receive the delivery confirmation that the device received the message by the time specified in the inbound request.

7. The method of any of descriptions 3-6, wherein:

the notification indicates a failure by the instant message service to receive the read confirmation that the recipient read the message by the time specified in the inbound request.

8. The method of any of descriptions 3-7, wherein:

the notification indicates that the recipient has blocked a sender of the message from sending messages to the device of the recipient.

9. The method of any of descriptions 1-8, wherein:

the read confirmation indicates that the device detected an input from the recipient while the message was being presented to the recipient by the device.

10. The method of any of descriptions 1-9, wherein:

the inbound request includes a name of the application from which the inbound request is received; and
the message is provided with the name of the application.

11. The method of description 10, wherein:

the message is provided with an option selected from a group consisting of:
blocking the application from sending future messages,
ignoring future messages from the application, and
replying to the application.

12. The method of any of descriptions 1-11, wherein:

the inbound request indicates that a further communication service among the plurality of communication services is disallowed for providing the message; and
the making of the first request to the instant message service is based on the inbound request indicating that the further communication service is disallowed for providing the message.

13. The method of any of descriptions 1-12, wherein:

the instant message service is a first-ranked communication service that is ranked higher among the plurality of communication services than a second-ranked communication service; and
the short message service is the second-ranked communication service.

14. The method of any of descriptions 1-13, wherein:

the plurality of communication services is ranked by cost to provide the message;
the instant message service costs less to provide the message than the short message service among the plurality of communication services; and
the making of the first request is based on the instant message service costing less than the short message service to provide the message.

15. The method of any of descriptions 1-13, wherein:

prior to the making of the first request, making a further request to a further instant message service among the plurality of communication services that the further instant message service provide the message to the device based on its phone number by the time specified in the inbound request; and
prior to the making of the first request, determining that the further instant message service acknowledged the further request but failed to receive a further confirmation selected from a group consisting of: a delivery confirmation that the device received the message by the time specified in the inbound request, and a read confirmation that the recipient read the message by the time specified in the inbound request; and wherein
the making of the first request is based on the determining that the further instant message service acknowledged the further request but failed to receive the further confirmation by the time specified in the inbound request.

16. The method of any of descriptions 1-15, wherein:

the instant message service is managed by a social networking service; and
the short message service is managed by a mobile telephony service.

17. A non-transitory machine-readable storage medium comprising instructions that, when executed by one or more processors of a machine, cause the machine to perform operations comprising:

receiving a message within an inbound request from an application that the message be provided by a time specified in the inbound request to a device of a recipient identified within the inbound request by a phone number of the device;
making a first request to an instant message service among a plurality of communication services that the instant message service provide the message to the device based on its phone number by the time specified in the inbound request;
determining that the instant message service acknowledged the first request but failed to receive a confirmation selected from a group consisting of: a delivery confirmation that the device received the message by the time specified in the inbound request, and a read confirmation that the recipient read the message by the time specified in the inbound request;
choosing a short message service among the plurality of communication services based on the determining that the instant message service acknowledged the first request but failed to receive the confirmation by the time specified in the inbound request received from the application, the choosing being performed by the one or more processors of the machine; and
making a second request to the short message service that the short message service provide the message to the device, the second request causing the short message service to provide the message to the device based on its phone number.

18. The non-transitory machine-readable storage medium of description 17, wherein the operations further comprise:

receiving a notification that references the first request from the instant message service; and wherein
the determining that the instant message service failed to receive the confirmation is based on the notification received.

19. A system comprising:

a message module configured to receive a message within an inbound request from an application that the message be provided by a time specified in the inbound request to a device of a recipient identified within the inbound request by a phone number of the device;
a service module configured to make a first request to an instant message service among a plurality of communication services that the instant message service provide the message to the device based on its phone number by the time specified in the inbound request; and
a processor configured by a control module to determine that the instant message service acknowledged the first request but failed to receive a confirmation selected from a group consisting of: a delivery confirmation that the device received the message by the time specified in the inbound request, and a read confirmation that the recipient read the message by the time specified in the inbound request;
the service module being configured to choose a short message service among the plurality of communication services based on the determining that the instant message service acknowledged the first request but failed to receive the confirmation by the time specified in the inbound request received from the application;
the service module being configured to make a second request to the short message service that the short message service provide the message to the device, the second request causing the short message service to provide the message to the device based on its phone number.

20. The system of description 19, wherein:

the service module is configured to receive a notification that references the first request from the instant message service; and
the control module configures the processor to determine that the instant message service failed to receive the confirmation based on the notification received.

21. A system comprising:

a message module configured to receive a message within an inbound request that the message be provided by a time specified in the inbound request to a recipient that is identified within the inbound request by a device identifier of a device of the recipient;
a service module configured to make a first request to a first communication service among a plurality of communication services that the first communication service provide the message to the device based on its device identifier by the time specified in the inbound request; and
a processor configured by a control module to determine that the first communication service acknowledged the first request but failed to receive a confirmation that references the first request by the time specified in the inbound request;
the service module being configured to choose a second communication service among the plurality of communication services based on the determining that the first communication service acknowledged the first request but failed to receive the confirmation by the time specified in the inbound request, the choosing being performed by a processor of a machine;
the service module being configured to make a second request to the second communication service that the second communication service provide the message to the device, the second request causing the second communication service to provide the message to the device based on its device identifier.

What is claimed is:

1. A method comprising:
receiving a message within an inbound request from an application that the message be provided by a time specified in the inbound request to a device of a recipient identified within the inbound request by a phone number of the device;
making a first request to an instant message service among a plurality of communication services that the instant message service provide the message to the device based on its phone number by the time specified in the inbound request;
determining that the instant message service acknowledged the first request but failed to receive a confirmation selected from a group consisting of: a delivery confirmation that the device received the message by the time specified in the inbound request, and a read confirmation that the recipient read the message by the time specified in the inbound request;
choosing a short message service among the plurality of communication services based on the determining that the instant message service acknowledged the first request but failed to receive the confirmation by the time specified in the inbound request received from the application, the choosing being performed by a processor of a machine; and
making a second request to the short message service that the short message service provide the message to the device, the second request causing the short message service to provide the message to the device based on its phone number.

2. The method of claim 1, wherein:
the determining that the instant message service failed to receive the confirmation is based on expiration of the time specified in the inbound request without receiving a notification from the instant messaging service that the confirmation was received by the instant messaging service.

3. The method of claim 1 further comprising:
receiving a notification that references the first request from the instant message service; and wherein
the determining that the instant message service failed to receive the confirmation is based on the notification received.

4. The method of claim 3, wherein:
the notification indicates that the phone number of the device does not correspond to any user registered with the instant message service.

5. The method of claim 3, wherein:
the notification indicates that the phone number of the device corresponds to a user registered with the instant message service but the user has an offline status with respect to the instant message service.

6. The method of claim 3, wherein:
the notification indicates a failure by the instant message service to receive the delivery confirmation that the device received the message by the time specified in the inbound request.

7. The method of claim 3, wherein:
the notification indicates a failure by the instant message service to receive the read confirmation that the recipient read the message by the time specified in the inbound request.

8. The method of claim 3, wherein:
the notification indicates that the recipient has blocked a sender of the message from sending messages to the device of the recipient.

9. The method of claim 1, wherein:
the read confirmation indicates that the device detected an input from the recipient while the message was being presented to the recipient by the device.

10. The method of claim 1, wherein:
the inbound request includes a name of the application from which the inbound request is received; and
the message is provided with the name of the application.

11. The method of claim 1, wherein:
the message is provided with an option selected from a group consisting of:
blocking the application from sending future messages,
ignoring future messages from the application, and
replying to the application.

12. The method of claim 1, wherein:
the inbound request indicates that a further communication service among the plurality of communication services is disallowed for providing the message; and
the making of the first request to the instant message service is based on the inbound request indicating that the further communication service is disallowed for providing the message.

13. The method of claim 1, wherein:
the instant message service is a first-ranked communication service that is ranked higher among the plurality of communication services than a second-ranked communication service; and
the short message service is the second-ranked communication service.

14. The method of claim 1, wherein:
the plurality of communication services is ranked by cost to provide the message;
the instant message service costs less to provide the message than the short message service among the plurality of communication services; and
the making of the first request is based on the instant message service costing less than the short message service to provide the message.

15. The method of claim 1 further comprising:
prior to the making of the first request, making a further request to a further instant message service among the plurality of communication services that the further instant message service provide the message to the device based on its phone number by the time specified in the inbound request; and
prior to the making of the first request, determining that the further instant message service acknowledged the further request but failed to receive a further confirmation selected from a group consisting of: a delivery confirmation that the device received the message by the time specified in the inbound request, and a read confirmation that the recipient read the message by the time specified in the inbound request; and wherein
the making of the first request is based on the determining that the further instant message service acknowledged the further request but failed to receive the further confirmation by the time specified in the inbound request.

16. The method of claim 1, wherein:
the instant message service is managed by a social networking service; and
the short message service is managed by a mobile telephony service.

17. A non-transitory machine-readable storage medium comprising instructions that, when executed by one or more processors of a machine, cause the machine to perform operations comprising:
receiving a message within an inbound request from an application that the message be provided by a time specified in the inbound request to a device of a recipient identified within the inbound request by a phone number of the device;
making a first request to an instant message service among a plurality of communication services that the instant message service provide the message to the device based on its phone number by the time specified in the inbound request;
determining that the instant message service acknowledged the first request but failed to receive a confirmation selected from a group consisting of: a delivery confirmation that the device received the message by the time specified in the inbound request, and a read confirmation that the recipient read the message by the time specified in the inbound request;
choosing a short message service among the plurality of communication services based on the determining that the instant message service acknowledged the first request but failed to receive the confirmation by the time specified in the inbound request received from the application, the choosing being performed by the one or more processors of the machine; and
making a second request to the short message service that the short message service provide the message to the device, the second request causing the short message service to provide the message to the device based on its phone number.

18. The non-transitory machine-readable storage medium of claim 17, wherein the operations further comprise:
receiving a notification that references the first request from the instant message service; and wherein
the determining that the instant message service failed to receive the confirmation is based on the notification received.

19. A system comprising:
a message module configured to receive a message within an inbound request from an application that the message be provided by a time specified in the inbound request to a device of a recipient identified within the inbound request by a phone number of the device;
a service module configured to make a first request to an instant message service among a plurality of communication services that the instant message service provide the message to the device based on its phone number by the time specified in the inbound request; and
a processor configured by a control module to determine that the instant message service acknowledged the first request but failed to receive a confirmation selected from a group consisting of: a delivery confirmation that the device received the message by the time specified in the inbound request, and a read confirmation that the recipient read the message by the time specified in the inbound request;
the service module being configured to choose a short message service among the plurality of communication services based on the determining that the instant message service acknowledged the first request but failed to receive the confirmation by the time specified in the inbound request received from the application;
the service module being configured to make a second request to the short message service that the short message service provide the message to the device, the second request causing the short message service to provide the message to the device based on its phone number.

20. The system of claim 19, wherein:
the service module is configured to receive a notification that references the first request from the instant message service; and
the control module configures the processor to determine that the instant message service failed to receive the confirmation based on the notification received.
